(19) United States
(12) Patent Application Publication
(10) Pub. No.: US 2011/0024991 A1
(43) Pub. Date: Feb. 3, 2011

(54) METALLIC FLAT GASKET AND MANUFACTURING METHOD

(76) Inventors: Rainer Capellmann, Burscheid (DE); James Stout, Pinckney, MI (US); Thomas Zurfluh, Evanston, IL (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/809,732

(22) PCT Filed: Sep. 4, 2008
(86) PCT No.: PCT/EP2008/007256

§ 371 Date: Sep. 27, 2010

(30) Foreign Application Priority Data
Dec. 19, 2007 (DE) 10 2007 061 084.1

(51) Int. Cl. F16J 15/08; C21D 8/02; F02F 11/00

(52) U.S. Cl. 277/592; 148/537

(57) ABSTRACT

Flat gaskets and in particular cylinder head gaskets for use in internal combustion engines include a metallic base support having at least one bead. The base support is made of steel comprising 0.50-1.30 wt % C, max. 3.0 wt % Si, max. 3.0 wt % Mn, max. 0.035 wt % P, max. 0.035 wt % S, max. 2.0 wt % Cr. This steel has a microstructure of ≧50% bainite.

The present invention relates to flat gaskets and in particular cylinder head gaskets, which may be used in internal combustion engines. The flat gasket has a metallic base support with at least one bead. The base support for this is shaped from steel with 0.50-1.30 wt % C, max. 3.0 wt % Si, max. 3.0 wt % Mn, max. 0.035 wt % P, max. 0.035 wt % S, max. 2.0 wt % Cr. The steel also has a microstructure of ≧50% of a bainite texture.

Cylinder head gaskets are flat gaskets which are characterized in that the sealing function and the transfer of screw forces are not separated from one another in comparison with other types of gaskets. The sealing function of a flat gasket is achieved by pressing on the gasket. However, when there is a separation of functions, the rigid metallic supporting frame takes over the function of the transfer of force and creates a defined sealing gap into which an elastic sealing material is pressed.

Known basic types of flat gaskets include, for example, gaskets made of an elastomer-coated metallic base support. The elastomer coating is normally beaded to increase the pressure. One possible embodiment is described in EP 1023549, for example, where the elastomer material also has peripheral elevations in the form of sealing lips.

Such gaskets are used in areas where no particularly great component tolerances need be compensated. All these flat gaskets have in common the fact that they are within the force flow of the housing or flange screw connections and thus are subject to high loads due to the screw forces. Different housing shapes and screw arrangements yield different supporting patterns in the course of sealing.

However, flat gaskets can be damaged more or less severely due to relative movements and high surface pressures between the flanges between which the gaskets are pressed. Such relative movements occur, for example, when flat gaskets are used in moving arrangements, such as in an engine, and cannot be hindered. The high contact pressure also cannot be reduced significantly due to the construction shape because otherwise the sealing effect of the flat gasket is reduced. Conversely, although a further increase in contact pressure and/or screw forces could reduce the relative movement, this would also cause an increased load on the gasket. The damages and mechanical wear phenomena could ultimately lead to failure of the sealing function.

The main critical areas where these wear phenomena occur are in the area of the screw connections in general. A small flange area or contact area of the gasket may also lead to a severe stress in local areas.

Therefore, mostly cylinder head gaskets of multilayer spring steels such as those designed according to DE 19808544 have proven successful as gaskets which meet the extreme requirements prevailing in the engine block. The steels used here are characterized in particular by comparatively large amounts of alloy metals such as chromium, nickel and to some extent manganese to achieve the desired properties in operation and in processing. The metal layers of the gaskets are often made of stainless austenitic steel 1.4310 (X10CrNi18-8) with C1300 according to the European Standard EN 10151. This steel has a high machinability on the one hand, which facilitates the initial development of beads and deformation limiters, while on the other hand, the material has a sufficient rigidity, load-bearing capability and stability, so that a bead is able to withstand the varying but substantial pressure burden without being subjected to a significant deformation.

It is a disadvantage that this metallic sealing material of stainless austenitic steel 1.4310 is difficult to process. This is attributed to the tendency of this so-called metastable austenitic steel to form deformation martensite, i.e., the metallic sealing material is hardened during shaping. Furthermore, this hardening may also have a negative effect on the function of the gasket. Another disadvantage of the austenitic steel 1.4310 to be mentioned is the relatively high cost of the material.

One object of the present invention is therefore to provide a gasket material for flat gaskets that is easy to process.

Another object of the present invention is to provide an inexpensive gasket material for flat gaskets.

Another object of the present invention is to provide a gasket material for flat gaskets having better function properties.

These objects have been achieved by providing the present flat gasket in which a steel comprising 0.50-1.30 wt % C, max. 3.0 wt % Si, max. 3.0 wt % Mn, max. 0.035 wt % P, max. 0.035 wt % S, max. 2.0 wt % Cr was used for at least one metallic base support having at least one bead. This steel also has a microstructure of ≧50% of a bainite texture.

It has surprisingly been found that bainitic steel is suitable for forming metallic gasket layers having a bead in a flat gasket, despite having an elongation at break (determined from uniaxial tensile tests) of between 3% and 15%, which is lower than that of the traditional austenitic steel 1.4310 (elongation at break 5% to 22%). In addition, the inexpensive steel used here is characterized by a good ductility, in particular in comparison with martensitic steel. In addition, a hardening, which is a disadvantage for the function, can be prevented with during the production of the gasket; with the austenitic chromium-nickel steels typically used for metallic gasket material, this hardening is attributed to a stress- and/or strain-induced formation of deformation martensite.

In the figures,

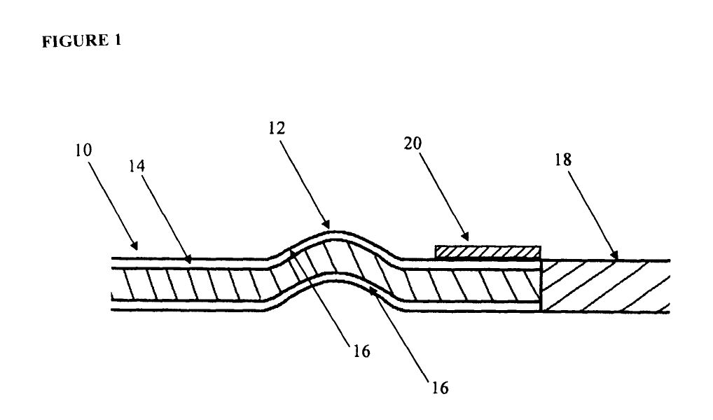

FIG. 1 shows a sectional view of an inventive flat gasket 10 having an embossed bead 12, where 14 denotes the base support of steel, containing 0.50-1.30 wt % C, max. 3.0 wt % Si, max. 3.0 wt % Mn, max. 0.035 wt % P, max. 0.035 wt % S, max. 2.0 wt % Cr and a microstructure of ≧50% of a bainite texture. Two additional metal layers 16 of aluminum are applied to the top side and/or bottom side of the base support. The flat gasket 10 has a deformation limiter 20 toward the combustion chamber opening 18.

According to a preferred embodiment of the invention, a flat gasket comprising at least one metallic base support having at least one bead is provided. The base support has a microstructure of ≧50% of a bainite texture. In addition, the base support is shaped from a steel comprising 0.50-1.30 wt % C, max. 3.0 wt % Si, max. 3.0 wt % Mn, max. 0.035 wt % P, max. 0.035 wt % S, max. 2.0 wt % Cr. The remaining amount is Fe and/or impurities. A single impurity is present here in the amount of ≦10⁻⁴ wt %, preferably ≦10⁻⁵ wt %, more preferably ≦10⁻⁶ wt %.

Those skilled in the art will be readily familiar with production of sheet metal material for corresponding metallic gaskets. The spring property is achieved by heat treatment and strain hardening. Further processing of the sheet metal material to form a flat gasket may take place in one or more operations. The combustion chamber is sealed by means of one or more beads in at least one of the gasket layers of the flat gasket. In the insulation of the gasket, the beads have the effect that the force of the screw connections with which the components to be sealed and the gasket are put under pressure with respect to one another is concentrated in a linear pressure along the bead cups. Those skilled in the art will be familiar with the design of the beads, which includes, for example, corresponding folding or pressing of the metal. Such beads are disclosed in DE 195 13 36, for example.

A metal layer consisting of any metal or a metal alloy, which is “softer” and/or better deformable than the flat gasket material, may be impressed upon the top side and bottom side of the flat gasket material. Those skilled in the art will be familiar with additional selection criteria for the material of the metal layer. Suitable metals and/or alloys include, for example, copper, tin or brass and preferably aluminum. It has surprisingly been found that the use of a soft metal leads to an improved microsealing in the area of a bead. Furthermore, the metal layer contributes toward an improved corrosion resistance. It is clear that because of different thermal expansion coefficients, metal layers of different metals and/or metal alloys may be applied to the top side and/or bottom side of the base support and may have different layer thicknesses in accordance with the requirements.

The steel used for the at least one metallic base support having at least one bead has a microstructure of ≧50% (area ratio) of a bainite texture, such as that which can be determined, for example, by means of a light micrograph of metallographic polished section through the strip steel used and can be determined by comparing the surfaces of bainitic steel with those of nonbainitic steel.

The steel is refined by bainitizing. Bainitization is understood to be a heat treatment method for steel. In contrast with conventional hardening, there is no martensitic conversion of the structure in bainitization, but instead the steel is converted to the bainite stage or an intermediate stage. First the steel is austenitized. Then it is quenched to a temperature above the so-called martensite starting temperature Mₛ and the steel is held at this temperature for a predefined period of time. This process is also referred to as isothermal conversion of austenite to bainite and is usually performed in a hot salt bath or metal bath. The degree of conversion of austenite to bainite, i.e., the percentage of bainite texture in the steel, can be controlled by the temperature and the duration of holding at that temperature. Production of bainitic steel and/or industrial components of bainitic steel is described in, for example, WO 2007/054063, WO 02/44429, EP 1 248 862, EP 0 896 068, EP 0 747 154 and EP 0 707 088. Those skilled in the art are familiar with changes in the method to obtain a steel having a microstructure of ≧50% of a bainite texture as well as the present composition.

The steel preferably has a microstructure of 50-100%, more preferably 60-100% and even more preferably 80-100% of a bainite texture. It has been found that these mixed phases, as mentioned above, combine the positive material properties of austenite and bainite for use in flat gaskets, in particular in the range of 80-100% of a bainite texture.

The steel may contain various amounts of the alloy constituents listed below independently of one another. For example, the steel may contain 0.5-1.30 wt % C, preferably 0.55-1.20 wt % C, and more preferably 0.70-1.05 wt % C. In addition, the steel may contain max. 3 wt % Si, preferably 0.15-2.00 wt % Si, more preferably 0.15-0.40 wt % Si and even more preferably 0.15-0.35 wt % Si. Other constituents include max. 3.0 wt % Mn, preferably 0.20-2.00 wt % Mn, more preferably 0.30-1.10 wt % Mn and even more preferably 0.30-0.90 wt % Mn; max. 0.035 wt % P, preferably max. 0.025 wt % P, max. 0.035 wt % S, preferably max. 0.025 wt % S; max. 2.00 wt % Cr, preferably max. 1.60 wt % Cr, more preferably max. 1.20 wt % Cr and even more preferably max. 0.4 wt % Cr and 0.90-1.20 wt % Cr.

According to a preferred embodiment, the steel has a tensile strength Rₘ of ≧1300 MPa and a yield strength Rₑ of ≧1050 MPa. Those skilled in the art are well acquainted with the determination of tensile strength and yield strength using suitable equipment.

According to another embodiment, the flat gasket also includes a supporting layer and/or a stopper layer. Those skilled in the art will be familiar with the design and production of a supporting layer and stopper layer. A supporting layer and/or a supporting element may be applied at any location of the gasket in various thicknesses and shapes, thus permitting a flexible design and variable use of the flat gasket. A stopper layer (also referred to as a “stopper”) here is a deformation-limiting mechanism by means of which the beads, which are deformable in height, are protected from inadmissibly high deformation. Such a deformation-limiting mechanism also at the same time represents a partial thickening of the flat gasket by means of which the engine components adjacent to the flat gasket are prestressed in such a way that the dynamic sealing gap vibration is reduced. Such a deformation-limiting device can be produced, for example, by welding an additional ring onto one of the layers of the flat gasket or by embossing elevations in one or more layers of the flat gasket. Such stoppers are known from the state of the art, e.g., from U.S. Pat. No. 5,713,580. In addition, DE 195 13 361 discloses a support layer for a flat gasket adjacent to the beaded function layer of spring steel, formed from another material having a lower tensile strength and a higher elongation at break and provided with a flange fold.

According to another preferred embodiment, one or more layers of the flat gasket are provided with an elastomer coating on one or both sides. This coating leads first to an improved microsealing effect in the area of a bead. In addition, this coating may also assume the additional function of preventing corrosion in certain applications.

According to another embodiment, the flat gasket comprises an elastomer gasket. Elastomer gaskets are often used for sealing low-pressure areas, which are in general exposed to lower thermal and mechanical stresses than the actual combustion chamber gasket. Elastomer gaskets are made of silicones, fluorosilicones or fluoroelastomers, for example.

According to another preferred embodiment of the present invention, the flat gasket component provided with a bainitic microstructure has a thickness of 0.1 to 2.5 mm.

Furthermore, a corrosion-resistant protective layer may be provided on the steel surface, e.g., to protect against coolant or vapor. Corrosion may be prevented, for example, by means of an enamel or an elastomer coating with nitrile rubber, for example, by applying a zinc phosphate or an iron-manganese phosphate conversion layer or a metallic coating with a more noble metal, e.g., by hot dipping in zinc or tin or plating with zinc, tin, nickel or aluminum. Those skilled in the art are readily familiar with other methods of applying such protective layers.

It should be clear that the inventive flat gasket and in particular the cylinder head gasket may be used not only in the production of internal combustion engines for automobiles but also in other internal combustion engines. The inventive flat gasket can also be produced using the same molds as those used for the flat gaskets according to the state of the art.

According to another preferred embodiment, a method for producing a flat gasket is provided, comprising the steps: (a) producing a steel having a chemical composition of 0.50-1.30 wt % C, max. 3.0 wt % Si, max. 3.0 wt % Mn, max. 0.035 wt % P, max. 0.035 wt % S, max. 2.0 wt % Cr, (b) using machining of the steel to form a sheet metal having a predetermined thickness, (c) subjecting the steel to a heat treatment to form a microstructure consisting of ≧50% bainite, (d) subjecting the steel plate to a punching operation to form a workpiece having one or more openings, (e) shaping the workpiece to form at least one metallic base support having at least one bead, (f) applying a coating, optionally a partial coating, for microsealing.

According to one embodiment, the strip steel contains 0.5-1.30 wt % C, preferably 0.55-1.20 wt % C and more preferably 0.70-1.05 wt % C. The steel also contains max. 3 wt % Si, preferably 0.15-2.00 wt % Si, more preferably 0.15-0.40 wt % Si and even more preferably 0.15-0.35 wt % Si. Other components include max. 3.0 wt % Mn, preferably 0.20-2.00 wt % Mn, more preferably 0.30-1.10 wt % Mn and even more preferably 0.30-0.90 wt % Mn; max. 0.035 wt % P, preferably max. 0.025 wt % P, max. 0.035 wt % S, preferably max. 0.025 wt % S, max. 2.00 wt % Cr, preferably max. 1.60 wt % Cr, more preferably max. 1.20 wt % Cr and even more preferably max. 0.4 wt % Cr or 0.90-1.20 wt % Cr.

According to another embodiment, the at least one metallic base support has a material thickness of 0.1 to 2.5 mm.

According to a preferred embodiment, the method includes the step of applying another metallic layer according to steps (b) or (c).

According to another embodiment, the method includes the step of applying an anticorrosion layer according to steps (c) or (d) or (e).

According to another embodiment, the method includes the step of applying a deformation limiter and/or integral molding of an elastomer gasket according to step (e).

Another metallic layer and/or a deformation limiter and/or an elastomer gasket are applied according to the method with which those skilled in the art will be familiar.

1. A flat gasket, comprising at least one metallic base support having at least one bead, wherein
the base support is shaped from a steel having 0.50-1.30 wt % C, max. 3.0 wt % Si, max. 3.0 wt % Mn, max. 0.035 wt % P, max. 0.035 wt % S, max. 2.0 wt % Cr and having a microstructure of ≧50% bainite.

2. The flat gasket according to claim 1,
wherein the steel contains 0.70-1.05 wt % C, 0.15-0.35 wt % Si, 0.30-0.90 wt % Mn, max. 0.025 wt % P, max. 0.025 wt % S and max. 0.4 wt % Cr or 0.90-1.20 wt % Cr.

3. The flat gasket according to claim 1,
wherein the steel has a tensile strength of 300 MPa and a yield strength of ≧1050 MPa.

4. The flat gasket according to claim 1,
wherein the at least one metallic base support has corrosion protection in the form of either an enamel, an elastomer coating, a zinc phosphate or iron-manganese phosphate conversion layer, a metallic coating or a metallic plating.

5. The flat gasket according to claim 1,
wherein the at least metallic base support has at least one deformation limiter.

6. The flat gasket according to claim 1,
wherein the at least one metallic base support has an elastomer gasket integrally molded on it.

7. The flat gasket according to claim 1,
wherein the at least metallic base plate has an elastomer coating.

8. The flat gasket according to claim 1,
wherein the at least one metallic base support has a material thickness of 0.1 to 2.5 mm.

9. A method for producing a flat gasket, comprising the steps:
(a) producing steel having a chemical composition of 0.50-1.30 wt % C, max. 3.0 wt % Si, max. 3.0 wt % Mn, max. 0.035 wt % P, max. 0.035 wt % S, max. 2.0 wt % Cr,
(b) forming the steel into sheet metal having a predetermined thickness,
(c) subjecting the steel sheet metal to a heat treatment to form a microstructure having ≧50% bainite,
(d) subjecting the steel sheet metal to a punching operation to form a workpiece having one or more openings,
(e) shaping the workpiece to form at least one metallic base support having at least one bead, and
(f) applying a microseal coating for microsealing.

10. The method according to claim 9,
wherein the steel sheet metal is fabricated to contain 0.70-1.05 wt % C, 0.15-0.35 wt % Si, 0.30-0.90 wt % Mn, max. 0.025 wt % P, max. 0.025 wt % S and max. 0.4 wt % Cr or 0.90-1.20 wt % Cr.

11. The method according to claim 9, wherein the at least metallic base support has a material thickness of 0.1 to 2.5 mm.

12. The method according to claim 9, wherein the method comprises the step of applying an additional metallic layer.

13. The method according to claim 9 including,
applying an anticorrosion coating before application of the microseal coating.

14. The method according to claim 9, including
applying a deformation limiter.

15. The method of claim 9, including integrally molding an elastomer gasket on the steel sheet metal.
